(19) United States
(12) Patent Application Publication
(10) Pub. No.: US 2006/0174301 A1
(43) Pub. Date: Aug. 3, 2006

(54) Video clip display device

(76) Inventors: Hideki Hashimoto, Kawasaki (JP); Tetsuhiko Okada, Hechioji (JP)

Correspondence Address: MCDERMOTT WILL & EMERY LLP, 600 13TH STREET, N.W., WASHINGTON, DC, 20005-3096, US

(21) Appl. No.: 11/325,624

(22) Filed: Jan. 5, 2006

(30) Foreign Application Priority Data
Jan. 6, 2005 (JP) 2005-001243

(51) Int. Cl. H04N 7/173; G06F 13/00; G06F 3/00; H04N 5/445

(52) U.S. Cl. 725/100; 725/131; 725/45; 725/40

(57) ABSTRACT

A video clip display device is provided capable of providing a viewer with a method of comfortably using a video clip irrespectively of a video clip generation method or distribution method. To achieve this, the video clip display device displays a video clip of a program on a display unit of a video display device that receives television broadcasting and displays a program or a display unit of a video recording device that receives television broadcasting and records a program, and includes a video clip acquiring unit that acquires the video clip of the program, a memory holding unit that stores the video clip acquired by the video clip acquiring unit and program information of the program in association with each other, and a control unit that replays the video clip of the program and performs a process in a zapping mode for display on the display unit.

### CROSS-REFERENCE TO RELATED APPLICATION

The present application claims priority from Japanese patent application No. JP 2005-001243 filed on Jan. 6, 2005, the content of which is hereby incorporated by reference into this application.

### BACKGROUND OF THE INVENTION

The present invention relates to a video clip display device in a television that receives television broadcasting, a television with a function of recording television broadcasting, a video recording device having incorporated therein a television tuner that receives television broadcasting, etc., the video clip display device that displays a digest, a preview, or the like created by using part of video of a television broadcasting program or part of video and audio thereof (hereinafter referred to as a video clip) and, more particularly, to a technology allowing easy selection of a television broadcasting program, easy pre-selection of a program to be recorded from among television broadcasting programs, and easy selection of data to be replayed from among a plurality of pieces of video data of television broadcasting programs.

Conventionally, in technologies for selecting a program to be viewed on the television or the like or a program to be pre-selected for recording, methods that have been generally used are those in which a program listing appearing on newspapers and magazines, such as television guide magazines, is used to select a channel, and those in which a G code appearing on such a program listing is used for pre-selection for recording.

Also, methods that have been in practical use in recent years are those in which an electronic program listing (such as EPG or iEPG; hereinafter simply referred to as EPG) is received through broadcast waves or the Internet for use in selecting a program or pre-selecting a program for recording Also, a method generally used for selecting a program being currently broadcasted is the one in which channels are each briefly viewed while being switched one after another so as to check the contents of the programs to select a desired program (such a method is hereinafter referred to as zapping).

This method allows a program to be intuitively selected, compared with the method of selecting a program by referring to a program listing on a newspaper or television guide or the method of selecting a program by referring to an EPG, and therefore has been widely used as a method of easily and reliably selecting a program.

Furthermore, in another method, a screen is divided into 4×4, that is, 16, in height and width for providing a thumbnail display of 16 channels at maximum to allow a program to be selected therefrom. Such a function is called channel surfing.

Still further, Japanese Patent Laid-Open Publication No. 2003-169312 discloses a method in which digest videos are received through the Internet and a portion is provided in an EPG screen for displaying the digest videos, and a method in which a button for making an instruction for digest replay is provided in an EPG screen and digest videos are replayed according to this instruction. Such methods of selecting a program or pre-selecting a program for recording with the use of digest videos have been presented as methods allowing the contents to be understood more easily than methods with the use of EPG information consisting only of characters, and allowing appropriate selection.

### SUMMARY OF THE INVENTION

However, conventional zapping has the following problems particularly when it comes to supporting digital broadcasting.

In television broadcasting, image information of 30 frames per second has to be transferred. In digital broadcasting, such image information is encoded to MPEG or the like for transfer. For example, in MPEG, 30 frames per second may include a frame having image information for one screen (I frame), and also a frame for which only the information about a difference between the previous image and the next image is transferred and which is generated (decoded) based on the image information about the previous and next images (B frame).

Therefore, images cannot be generated until an I frame is received even if the channel is switched, thereby causing a delay corresponding to a time for waiting an I frame and a time for decoding the transferred image information. As a result, even if the channel is switched, images cannot be viewed immediately. That is, a first problem is that channel switching cannot be made smoothly.

Also, for zapping, videos currently being broadcasted are used. Therefore, it is impossible to know what program is being broadcasted during a commercial message by chance. Furthermore, during a commercial message between programs being switched, it is impossible to obtain information about a program that will start next. Therefore, a second problem is that a viewer has to wait for a while and then again switch to the desired channel for checking.

Still further, in channel surfing, in order to display videos of a plurality of channels with one tuner, image information has to be captured while channel switching is being performed in a time division manner. Therefore, when videos for 16 channels are to be displayed, only two frames or so can be displayed at the best, although images of 30 frames are supposed to be displayed per second. Thus, a third problem is that it is impossible to smoothly display moving pictures.

In digital broadcasting, a delay occurs due to a time for waiting a frame having image information for one screen (I frame) and a time for decoding, and therefore it is difficult even to display two frames per second.

To solve the above problems, for smoothly displaying moving pictures on a plurality of channels at the same time, a method of using tuners as many as the number of channels can be taken. However, in this method, there is a fourth problem that channels not required for normal viewing have to be provided, thereby requiring superfluous cost.

Still further, Japanese Patent Laid-Open Publication No. 2003-169312 mainly discloses technologies related to a method of generating a digest (video clip) from a television program and a method of providing EPG including digests by cooperation among a program creator, a digest creator, and a digest distributor. However, usability of viewers using distributed digests (video clips) is not so much taken into consideration.

Regarding a video clip using method for viewers disclosed in Japanese Patent Laid-Open Publication No. 2003-169312, two technologies are disclosed therein, one in which a video clip is displayed on an EPG screen, and the other in which a button for making an instruction for video clip replay is provided on an EPG screen.

In the case where a video clip is displayed on the EPG screen, the screen to be displayed is small, thereby posing a fifth problem in which it is difficult to obtain program information. For example, when a commercial message for a program is provided as a video clip, character information included therein is also important, but is difficult to read if the screen is small.

In the case where a button for making an instruction for video clip replay is provided on an EPG screen, the viewer has to always return to the EPG screen for each replay, thereby posing a sixth problem in which smooth operability, which can be obtained in zapping, cannot be achieved.

Also, Japanese Patent Laid-Open Publication No. 2003-169312 does not recite a technology regarding an operating method that can replace zapping.

Therefore, an object of the present invention is to provide a video clip display device capable of providing a viewer with a method of comfortably using a video clip irrespectively of a video clip generation method or distribution method.

According to the present invention, there is provided a video clip display device that displays a video clip of a program on a display unit of a video display device that receives television broadcasting and displays a program or on a display unit of a video recording device that receives television broadcasting and records a program, the video clip display device includes: a video clip acquiring unit that acquires the video clip of the program; a memory holding unit that stores the video clip acquired by the video clip acquiring unit and program information of the program in association with each other; and a control unit that performs a process in a zapping mode in which the video clip of the program is replayed and displayed on the display unit.

According to the present invention, a new video display mode (zapping mode) is provided in which video clips that present programs are stored in advance in a video clip display device and the stored video clip videos are used instead of videos being broadcasted, thereby making it possible to smoothly switching the channel.

Also, since only the video clips that present the programs are stored, such situations as those where program information cannot be acquired during a commercial message do not occur. Also, a video clip in the next time zone can be viewed.

Furthermore, since the video clips are stored in advance in the memory holding unit of the video clip display device, there is no need for a plurality of tuners in order to acquire video clips for a plurality of channels.

Still further, with provision of the zapping mode dedicated to video clip replay, functions and operation methods unique to the zapping mode are provided, thereby improving viewers' usability.

### DESCRIPTION OF THE DRAWINGS

FIG. 1 is a structural diagram showing the structure of a video clip display device according to one embodiment of the present invention.

FIG. 2 is a view showing one example of video clip display by the video clip display device according to one embodiment of the present invention.

FIG. 3 is a drawing for describing data stored in a memory holding unit of the video clip display device according to one embodiment of the present invention.

FIG. 4 is a drawing of one example of a video clip information storage layout in the memory holding unit of the video clip display device according to one embodiment of the present invention.

FIG. 5 is a flowchart showing a video clip acquiring operation of the video clip display device according to one embodiment of the present invention.

FIG. 6 is a flowchart showing another video clip acquiring operation of the video clip display device according to one embodiment of the present invention.

FIG. 7 is a flowchart showing the operation of a video clip acquiring process of the video clip display device according to one embodiment of the present invention.

FIG. 8 is a flowchart showing the operation of a zapping mode process of the video clip display device according to one embodiment of the present invention.

FIG. 9A is a drawing for describing an operation at the time of transition to a zapping mode in the video clip display device according to one embodiment of the present invention.

FIG. 9B is a drawing for describing an operation at the time of transition to a zapping mode in the video clip display device according to one embodiment of the present invention.

FIG. 10 is a drawing for describing succession to respective modes in the video clip display device according to one embodiment of the present invention.

FIG. 11 is a drawing for describing an automatic channel update mode of the zapping mode in the video clip display device according to one embodiment of the present invention.

FIG. 12 is a drawing for describing an automatic channel update mode (skip) of the zapping mode in the video clip display device according to one embodiment of the present invention.

FIG. 13 is a drawing for describing an automatic program update mode of the zapping mode in the video clip display device according to one embodiment of the present invention.

FIG. 14 is a drawing for describing an automatic program update mode (skip) of the zapping mode in the video clip display device according to one embodiment of the present invention.

FIG. 15 is a drawing for describing an automatic time zone update mode of the zapping mode in the video clip display device according to one embodiment of the present invention.

FIG. 16 is a drawing for describing an automatic time zone update mode (skip) of the zapping mode in the video clip display device according to one embodiment of the present invention.

FIG. 17A is a drawing for describing another method of displaying video clips according to one embodiment of the present invention.

FIG. 17B is a drawing for describing another method of displaying video clips according to one embodiment of the present invention.

FIG. 18 is a flowchart of an operation at the time of channel switching in the video clip display device according to a second embodiment of the present invention.

### DESCRIPTION OF THE PREFERRED EMBODIMENTS

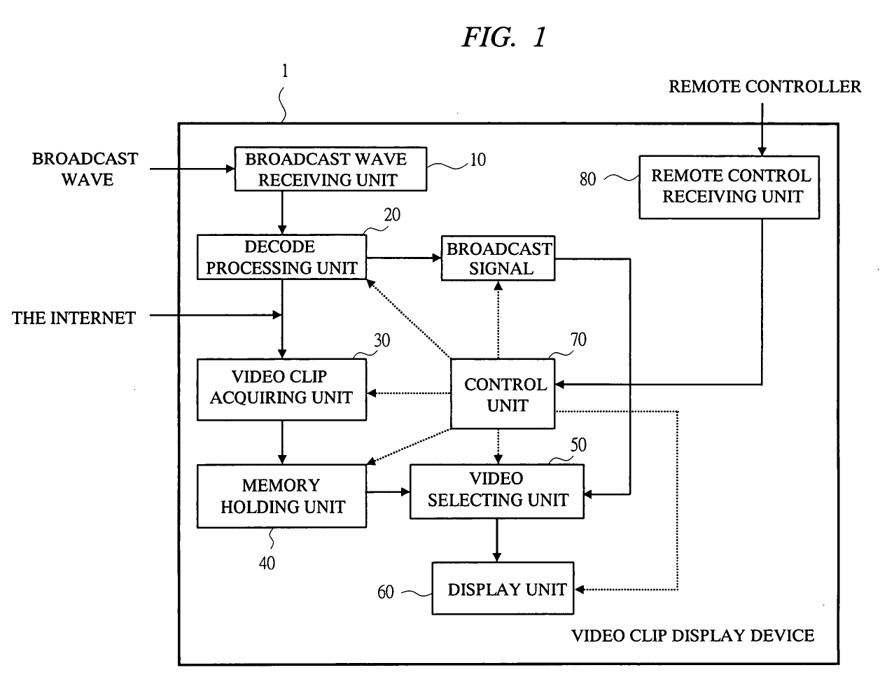

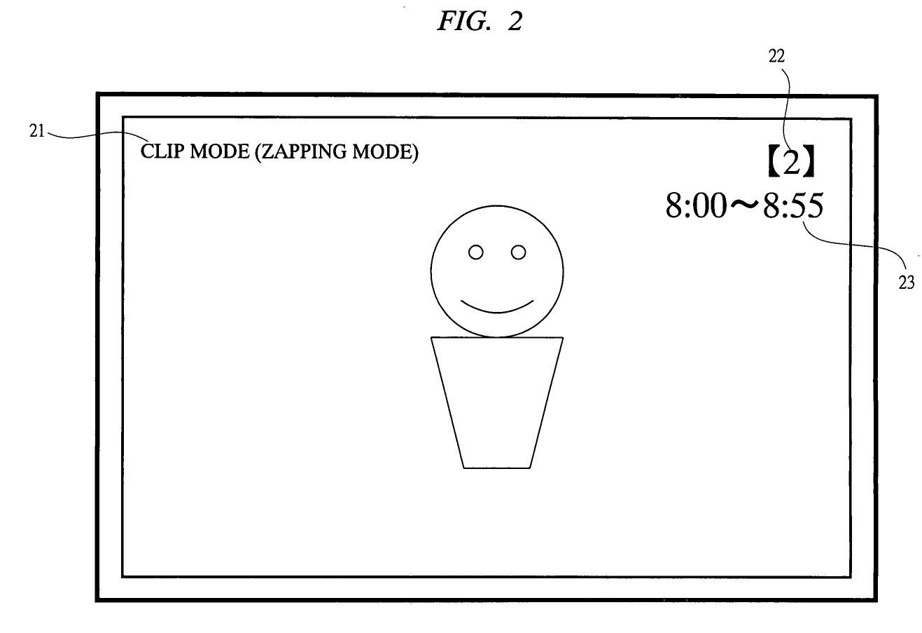

With reference of FIGS. 1 and 2, the structure of a video clip display device according to one embodiment of the present invention and an example of video clip display thereof are described. FIG. 1 is a structural diagram showing the structure of a video clip display device according to one embodiment of the present invention, and FIG. 2 is a view showing one example of video clip display by the video clip display device according to one embodiment of the present invention.

In FIG. 1, a video clip display device 1 includes a broadcast wave receiving unit 10, a decode processing unit 20, a video clip acquiring unit 30, a memory holding unit 40, a video selecting unit 50, a display unit 60, a control unit 70, a remote control receiving unit 80.

Also, the video clip display device 1 is incorporated in or connected to a television that receives television broadcasting, a video display device, such as a television having a function of recording television broadcasting, or a video recording device having incorporated therein a television tuner that receives television broadcasting. In the internal structure of the video clip display device 1, components that can be shared with such a television or video recording device are shared therewith.

The broadcast wave receiving unit 10 receives a broadcast wave for output to the decode processing unit 20.

The decode processing unit 20 performs a decode process on the broadcast wave received at the broadcast wave receiving unit 10, and then generates a video clip or a broadcast signal.

The video clip acquiring unit 30 acquires the video clip obtained through the decode process at the decode processing unit 20.

The memory holding unit 40 has stored therein the video clip and/or EPG data.

The video selecting unit 50 selects a broadcast signal subjected to a decode process and a video clip stored in the memory holding unit 40, and causes the display unit 60 to display.

The control unit 70 controls the broadcast wave receiving unit 10, the decode processing unit 20, the video clip acquiring unit 30, the memory holding unit 40, the video selecting unit 50, and the display unit 60, thereby controlling the entire video clip display apparatus 1.

The remote control receiving unit 80 receives a signal from a remote controller, and then outputs that remote control signal to the control unit 70.

In the video clip display device 1 shown in FIG. 1, a video clip is acquired through broadcast waves or the Internet, and then is stored in the memory holding unit 40.

First, the broadcast waves are received by the broadcast wave receiving unit 10 and are then decoded by the decode processing unit 20. Thereafter, the decoded video clip is acquired by the video clip acquiring unit 30 and is then stored in the memory holding unit 40.

However, when a video clip is acquired through the Internet, a decode process at the decode processing unit 20 is not required. Upon reception, the video clip is immediately acquired by the video clip acquiring unit 30 and is then stored in the memory holding unit 40.

Also, in order to display the video clip stored in the memory holding unit 40, the video clip is selected by the video selecting unit 50 and is then displayed on the display unit 60.

A display example of this video clip in the case of a display in a zapping mode, for example, is as shown in FIG. 2, wherein a “zapping mode” 21 indicating that the display is in a zapping mode, a “channel” 22 in the zapping mode currently being displayed, and a “time zone (start time and end time)” 23 are displayed in the displayed video clip.

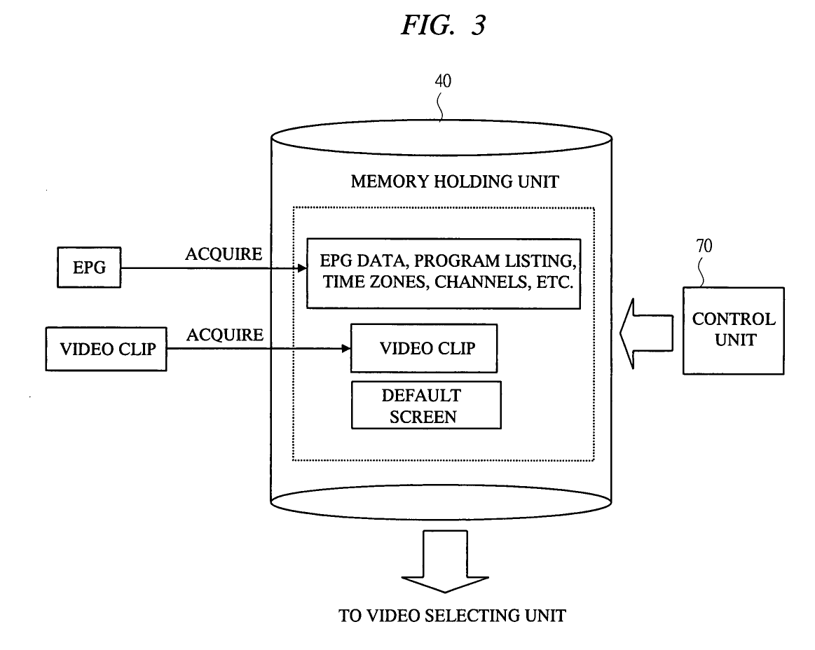

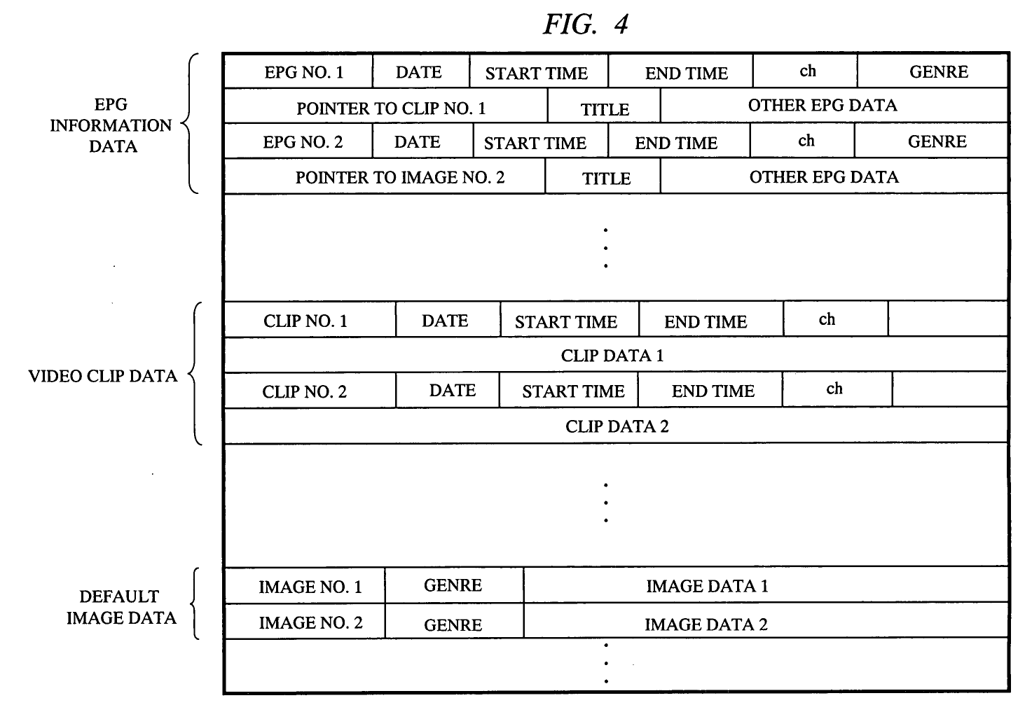

Next, with reference to FIGS. 3 and 4, data stored in the memory holding unit of the video clip display device according to one embodiment of the present invention is described. FIG. 3 is a drawing for describing data stored in a memory holding unit of the video clip display device according to one embodiment of the present invention, and FIG. 4 is a drawing of one example of a video clip information storage layout in the memory holding unit of the video clip display device according to one embodiment of the present invention.

As shown in FIG. 3, the memory holding unit 40 has stored therein program information acquired from EPG information, including a program listing, time zones, and channels, and video clips acquired by the video clip acquiring unit 30. These pieces of program information and video clips are stored at any time and, for example, a default screen to be displayed instead of video clips when no video clips are present is also stored.

Also, an example of a video clip information storage layout in the memory holding unit 40 is as shown in FIG. 4, wherein, together with information acquired from EPG including “date”, “start time”, “end time”, “ch (channel)”, “genre”, “title”, and “other EPG data”, a pointer to video clip data and a pointer to default image data are stored.

As for these pointers, addresses may be used when the memory holding unit 40 is implemented by a memory, and file names or i node numbers may be used when the memory holding unit 40 is implemented by a file system.

These pointers can be obtained at the time of acquiring EPG information or at the time of acquiring clip data by searching for already-acquired video clip data, EPG information data, or default image data, with “date”, “start time”, “end time”, “ch”, “title”, “genre”, etc., being taken as a key.

In the example of FIG. 4, a program labeled as “EPG No. 1” holds a pointer to a corresponding video clip, whilst a program labeled as “EPG No. 2” holds a pointer to the default image. When neither the corresponding video clip nor the default image is found, a dummy NULL pointer is held, for example, so as to cause the EPG information itself to be displayed at the time of display.

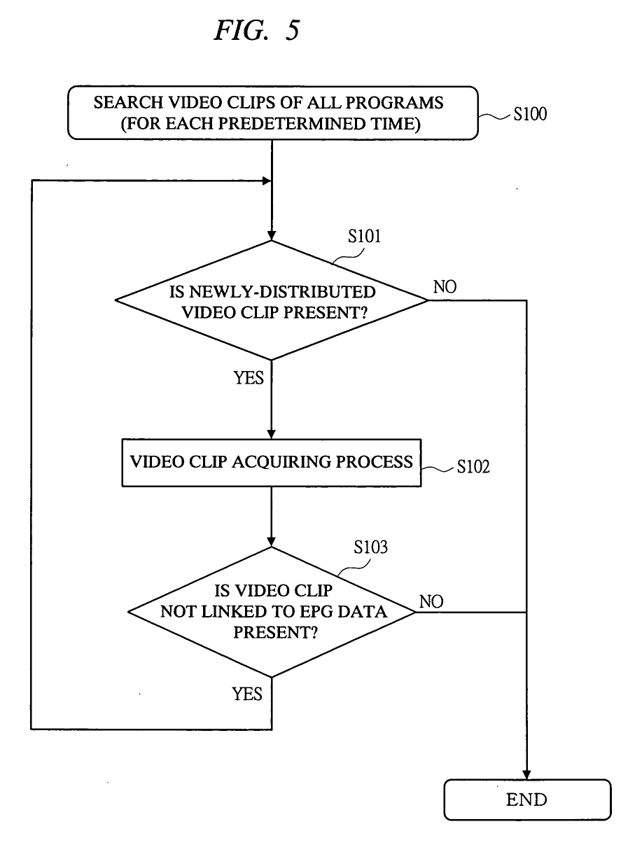

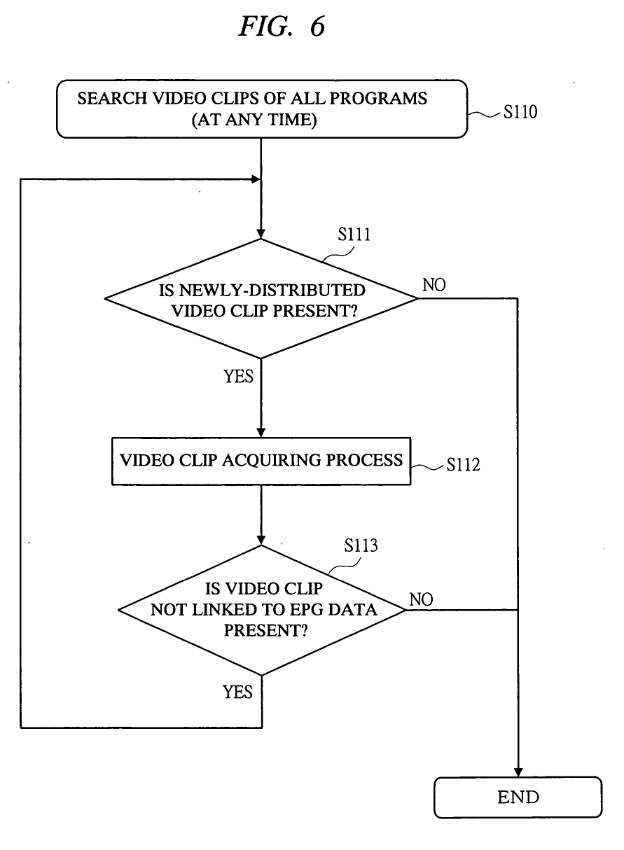

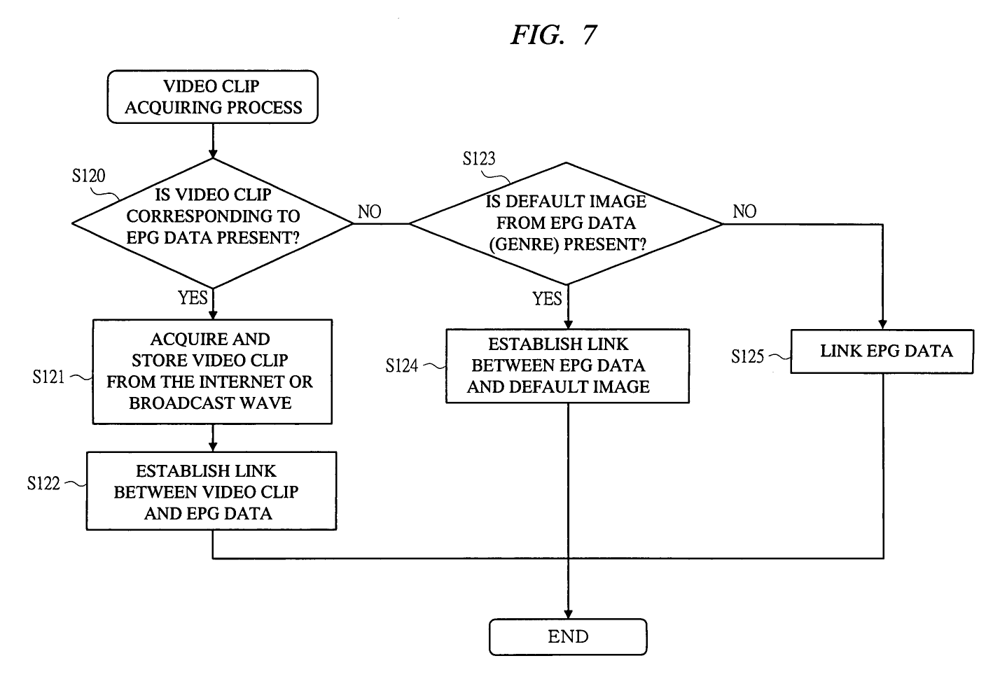

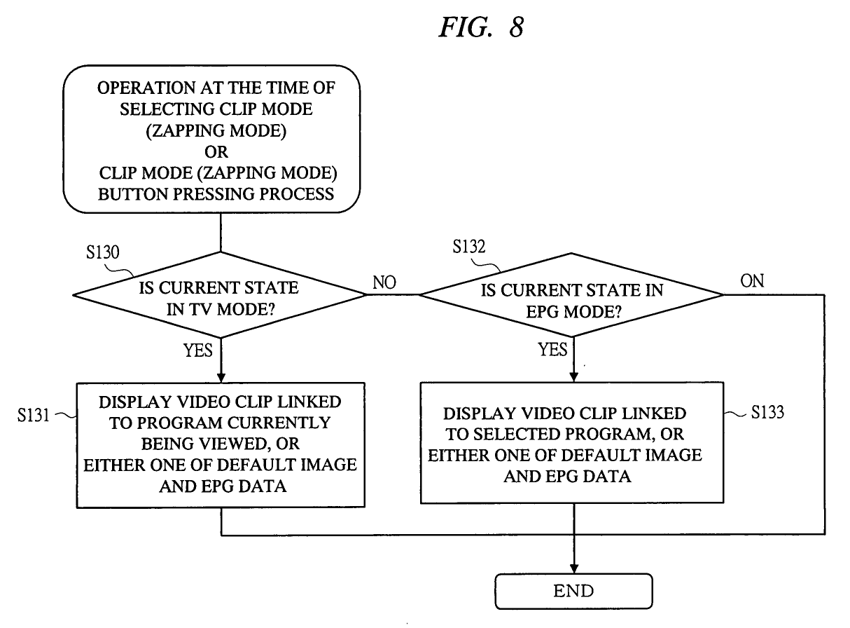

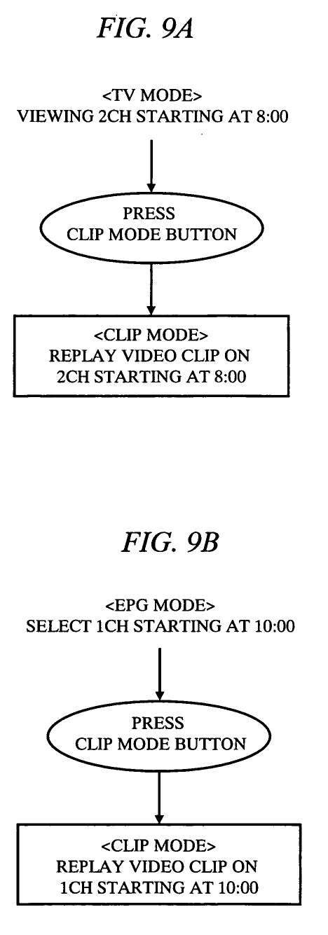

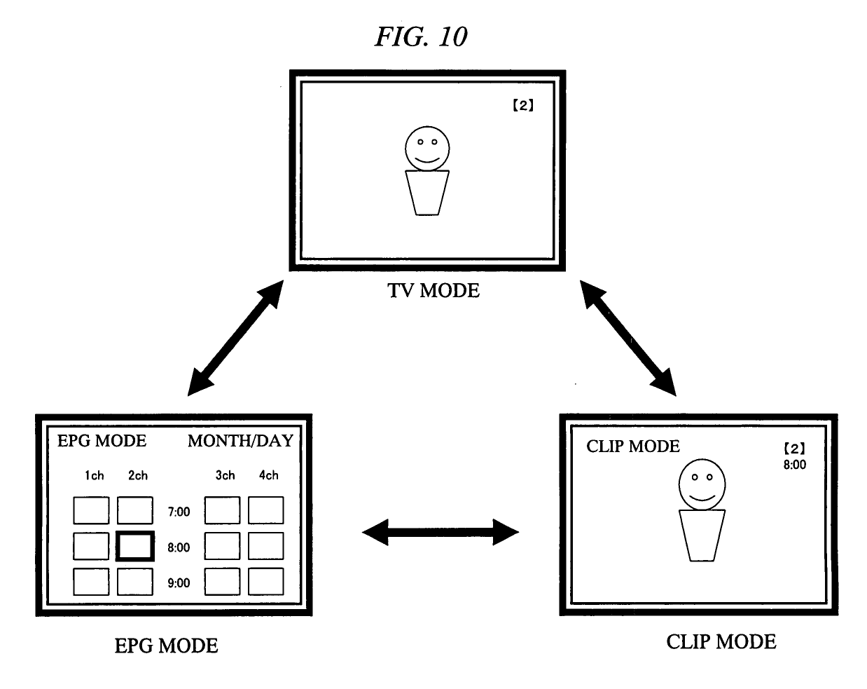

Next, with reference to FIGS. 5 to 10, the operation of the video clip display device according to one embodiment of the present invention is described. FIGS. 5 to 10 are drawings for describing the operation of the video clip display device according to one embodiment of the present invention, wherein FIGS. 5 and 6 are flowcharts each showing a video clip acquiring operation, FIG. 7 is a flowchart showing the operation of a video clip acquiring process, FIG. 8 is a flowchart showing an operation of a zapping mode process, FIGS. 9A and 9B are drawings for describing an operation at the time of transition to the zapping mode, and FIG. 10 is a drawing for describing succession to respective modes.

In the video clip acquiring operation through the Internet, as shown in FIG. 5, video clips transferred through the Internet are first searched for each predetermined time (S100) to determine whether a newly-distributed video clip is present (S101).

If it is determined in S101 that a newly-distributed video clip is present, a video clip acquiring process is performed to establish a link between the EPG data and the video clip (S102).

Here, in the video clip acquiring process in S102, when a video clip corresponding to the EPG data is not present, the process ends with a default image associated with the EPG data or information included in the EPG data being linked, and when another newly-distributed video clip is acquired, if a video clip corresponding to the EPG data is present, that video clip is linked to the EPG data.

If it is determined in S101 that a newly-distributed video clip is not present, the process ends.

Then, after the video clip acquiring process in S102, it is determined whether a video clip not linked to EPG data is present (S103). If it is determined in S103 that a video clip not linked to EPG data is present, the procedure returns to S101 to again perform a video clip search on the Internet and perform a video clip acquiring process.

If it is determined in S103 that a video clip not linked to EPG data is not present, the video clip search ends.

A video clip acquiring operation through broadcast waves is as shown in FIG. 6, wherein video clips transferred through the Internet are first searched at any time (S110) to determine whether a newly-distributed video clip is present (S111).

If it is determined in S111 that a newly-distributed video clip is present, a video clip acquiring process is performed to establish a link between the EPG data and the video clip (S112).

Here, in the video clip acquiring process in S112, when a video clip corresponding to the EPG data is not present, the process ends with a default image associated with the EPG data or information included in the EPG data being linked, and when another newly-distributed video clip is acquired, if a video clip corresponding to the EPG data is present, that video clip is linked to the EPG data.

If it is determined in S111 that a newly-distributed video clip is not present, the process ends.

Then, after the video clip acquiring process in S112, it is determined whether a video clip not linked to the EPG data is present (S113). If it is determined in S113 that a video clip not linked to the EPG data is present, the procedure returns to S111 to again perform a video clip search on the Internet and perform a video clip acquiring process.

If it is determined in S113 that a video clip not linked to the EPG data is not present, the video clip search ends.

The operation of the video clip acquiring process in S102 of FIG. 5 and S112 of FIG. 6 is as shown in FIG. 7, wherein it is first determined whether a video clip corresponding to the EPG data is present (S120).

If it is determined in S120 that a video clip corresponding to the EPG data is present, the video clip is acquired and stored through the Internet or broadcast waves (S121), and then a link is established between the video clip and the EPG data (S122).

If it is determined in S120 that a video clip corresponding to the EPG data is not present, it is determined whether a default image, in place of a video clip, from the EPG data (genre) is present (S123).

If it is determined in S123 that a default image from the EPG data (genre) is present, a link is established between the default image and the EPG data (S124). If it is determined in S123 that a default image from the EPG data (genre) is not present, the EPG data itself is linked to the EPG data (S125).

Here, as the video clip to be acquired in the present embodiment, a preview for the next episode that is aired at the last of a drama series or a cartoon, or a program commercial message created for advertising a program can be used. Also, a video clip created by an organization other than a program producer may be used.

Furthermore, to acquire a video clip, a method of acquiring a video clip distributed with EPG information or a method of acquiring a video clip through the Internet by using an URL distributed with EPG information may be used.

Still further, in the present embodiment, three display modes are provided, that is, a TV mode for viewing normal TV, an EPG mode for operating through an EPG, and a zapping mode for displaying video clips of programs. Switching among these three modes is performed through, for example, a selecting operation with a menu displayed on a screen or through a button of a remote controller.

Here, in the case of the operation through a remote controller, a switching button for switching between the TV mode and the EPG mode may also serve as a switching button for switching to the zapping mode for use as a switching button for switching among the TV mode, the EPG mode, and the zapping mode. Alternatively, a dedicated zapping mode button may be provided on a remote controller.

The operation of transition to the zapping mode upon selection of the zapping mode or upon pressing of the zapping mode button is as shown in FIG. 8, wherein, in order to decide the state upon selection of the zapping mode or upon pressing of the zapping mode button, it is determined whether the current state is in the TV mode (S130).

If it is determined in S130 that the current state is in the TV mode, a video clip linked to the program currently being viewed, or either one of the default image and the EPG data is displayed (S131).

If it is determined in S130 that the current state is not in the TV mode, it is determined whether the current state is in the EPG mode (S132).

If it is determined in S132 that the current state is in the EPG mode, a video clip linked to the program selected based on the EPG, or either one of the default image and the EPG data is displayed (S133).

If it is determined in S132 that the current state is not in the EPG mode, the current state is in the zapping mode. Therefore, the process ends and a display in the current zapping mode continues.

In a specific example of a video clip replay operation based on the above operation, when a zapping mode button on a remote controller is pressed, for example, while a program on 2ch starting at 8:00 is currently being viewed, as shown in FIG. 9A, after a transition to the zapping mode, a video clip corresponding to the program on 2ch starting at 8:00 is replayed.

Also, when the zapping mode button on the remote controller is pressed with a program on 1ch starting at 10:00 currently being selected in the EPG mode, for example, as shown in FIG. 9B, after a transition to the zapping mode, a video clip corresponding to the program on 1ch starting at 10:00 is replayed.

Similarly, as for transitions among the respective modes, as shown in FIG. 10, when a transition is made to any one of the TV mode, the EPG mode, and the zapping mode, succession to the program currently being displayed or selected is made so as to perform a display in the displayed or selected state.

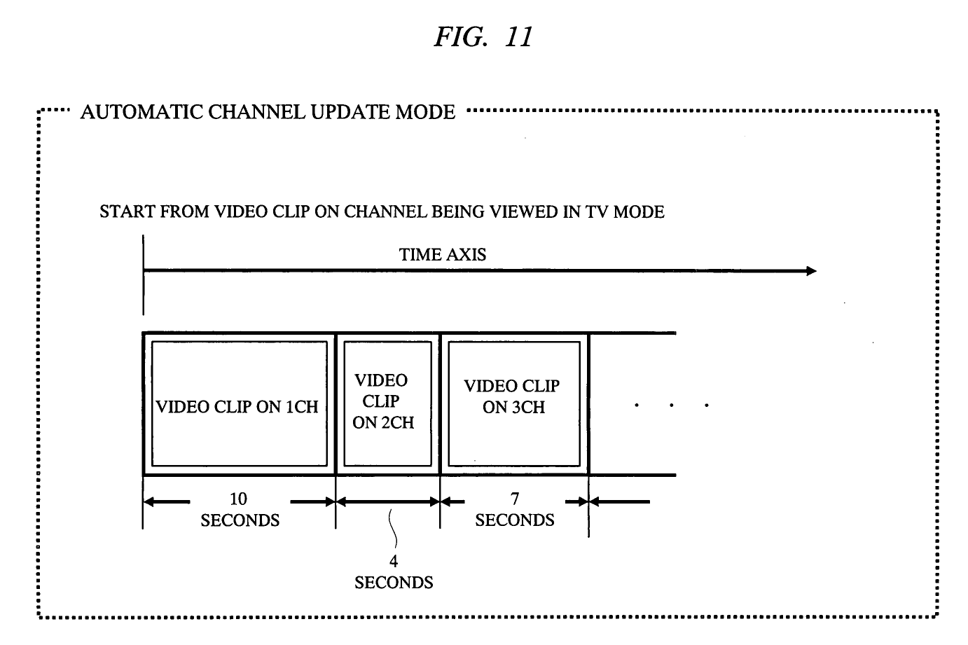

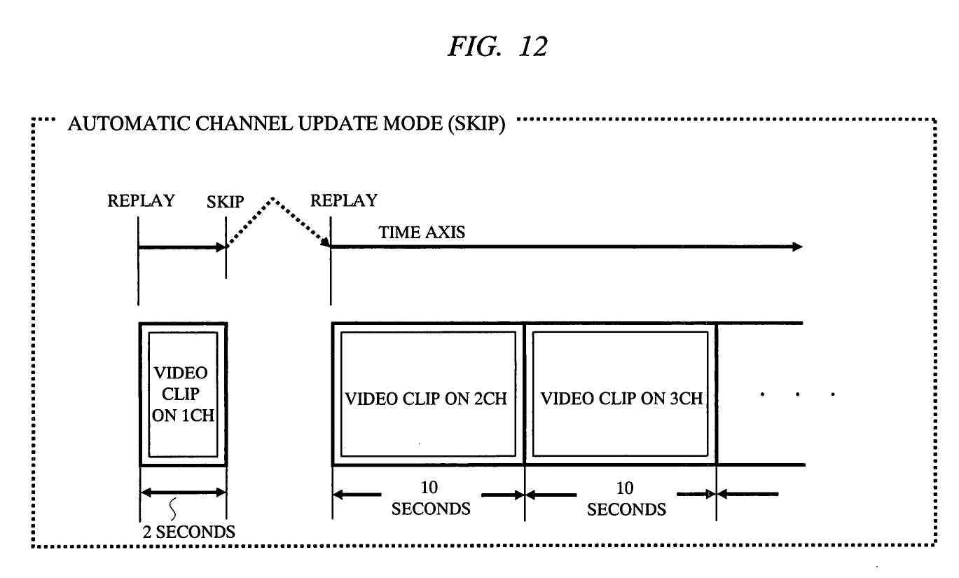

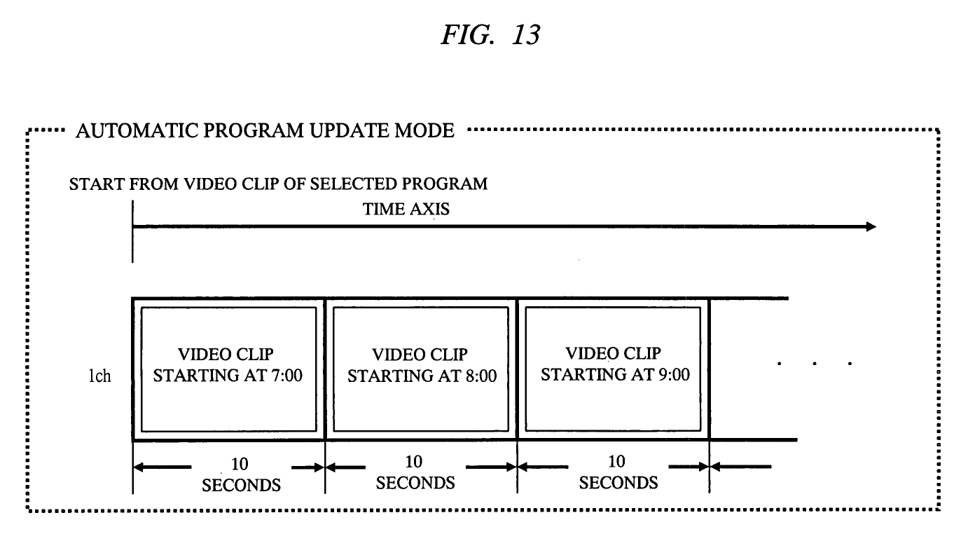

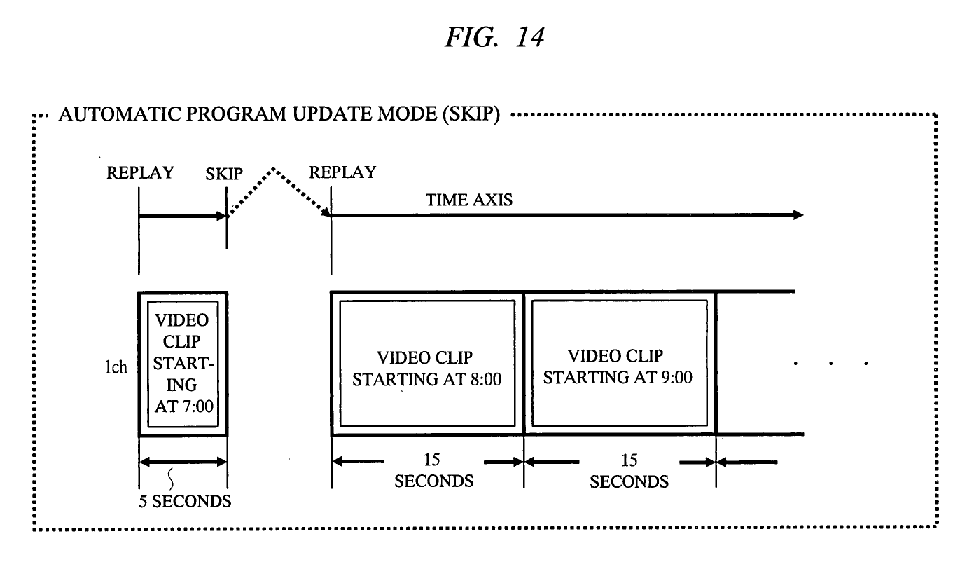

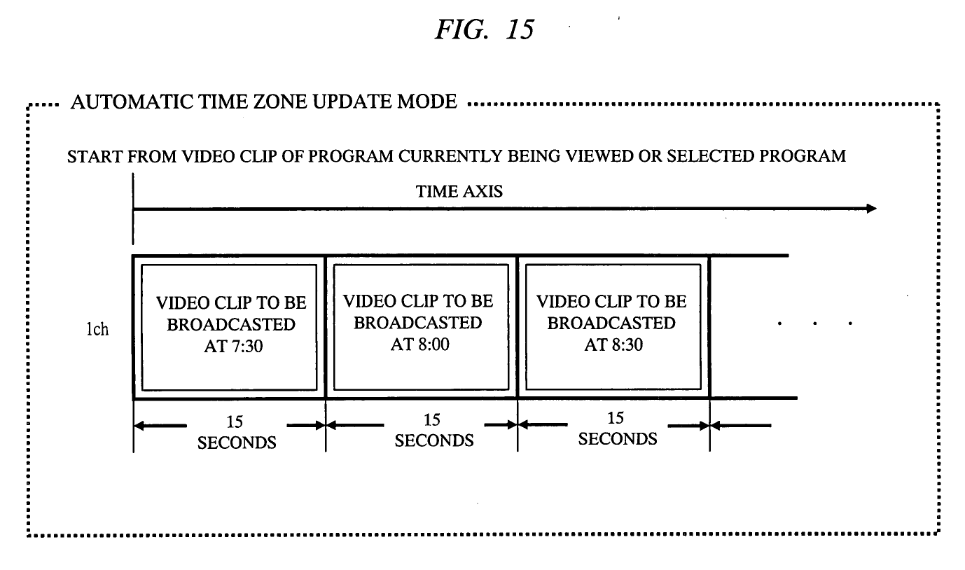

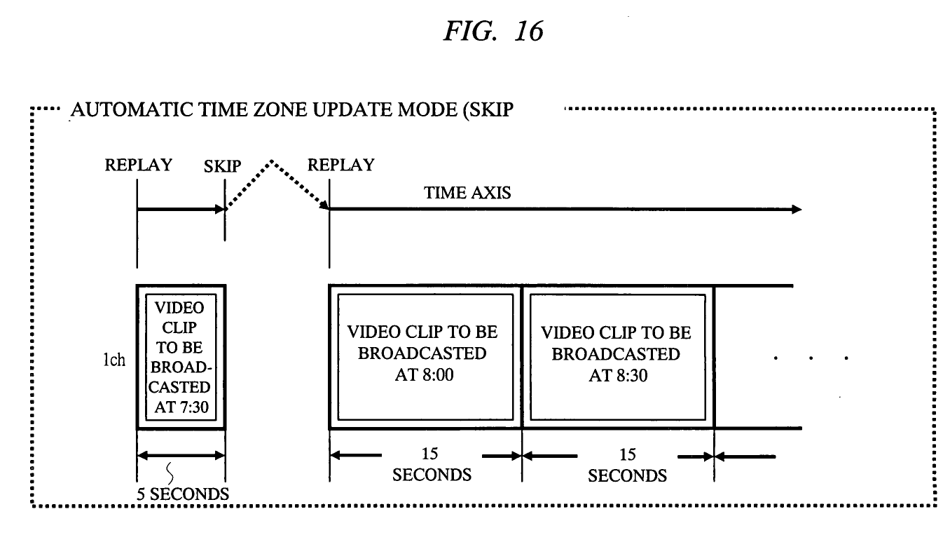

Next, with reference to FIGS. 11 to 16, a display mode of the zapping mode of the video clip display device according to one embodiment of the present invention is described. FIGS. 11 to 16 are drawings for describing the zapping mode display mode of the video clip display device according to one embodiment of the present invention, wherein FIG. 11 is a drawing for describing an automatic channel update mode of the zapping mode, FIG. 12 is a drawing for describing an automatic channel update mode (skip) of the zapping mode, FIG. 13 is a drawing for describing an automatic program update mode of the zapping mode, FIG. 14 is a drawing for describing an automatic program update mode (skip) of the zapping mode, FIG. 15 is a drawing for describing an automatic time zone update mode of the zapping mode, and FIG. 16 is a drawing for describing an automatic time zone update mode (skip) of the zapping mode.

In the present embodiment, when a transition is made to the zapping mode, as described above, the video clip of the program being viewed in the TV mode or the program selected in the EPG mode is displayed.

The subsequent video clips to be displayed are different depending on the display mode of the zapping mode.

First, when the display mode is an automatic channel update mode, as shown in FIG. 11, after the video clip being replayed is over, a video clip of a program on a different channel in the same time zone is selected for display in succession.

Also, when a channel-up or channel-down operation is performed through a remote control operation during a display in the automatic channel update mode, as shown in FIG. 12, the video clip being displayed can be skipped to display a video clip on the next channel or a video clip on the previous channel.

Such a channel-up or channel-down operation through a remote control operation can be performed by, for example, operating an up button, a down button, or the like provided on the remote controller.

Furthermore, when the display mode is an automatic program update mode, as shown in FIG. 13, after the video clip being replayed is over, a video clip of a program on the same channel in a different time zone is selected for display in succession.

Also, when a next program operation or a previous program operation is performed through a remote control operation during a display in the automatic program update mode, as shown in FIG. 14, the video clip being displayed can be skipped to display a video clip of a program in the next time zone or a video clip of a program in the previous time zone.

Such a next program operation or a previous program operation through a remote control operation can be performed by, for example, operating a right button, a left button, or the like provided on the remote controller.

Still further, when the display mode is an automatic time zone update mode, as shown in FIG. 15, after the video clip being replayed is over, a video clip of a program starting 30 minutes later than the time when a successive replay starts is selected for display.

Also, when a next time zone operation or a previous time zone operation is performed through a remote control operation during a display in the automatic time zone update mode, as shown in FIG. 16, the video clip being displayed can be skipped to display a video clip of a program in the next time zone or a video clip of a program in the previous time zone.

Such a next time zone operation or a previous time zone operation through a remote control operation can be performed by, for example, operating a right button, a left button, or the like provided on the remote controller.

As described above, in the present embodiment, in order to provide a method of easily and readily selecting a program in an intuitive manner equivalent to zapping, a new video display mode (zapping mode) is provided in which video clips that present programs are stored in advance in the video clip display apparatus 1 and the stored video clip videos are used for zapping instead of videos being broadcasted. Since the video clips stored in advance in the memory holding unit 40 of the video clip display device 1 are used, the above-described first problem can be solved by using a decoder having a sufficiently high processing capability, by using an encoding scheme that allows decoding at higher speed, or by pre-decoding part of the beginning of the encoded file.

Also, since only the video clips that present programs are stored, such situations as those where program information cannot be acquired during a commercial message do not occur. Furthermore, a video clip in the next time zone can be viewed. Therefore, the above-described second problem does not occur.

Still further, similarly, when a function equivalent to channel surfing is achieved by using video clip videos stored in place of the videos currently being broadcasted, the video clips stored in advance in the memory holding unit 40 of the video clip display apparatus 1 are used. Therefore, the above-described third problem can be solved by using a decoder having a sufficiently high processing capability, by using an encoding scheme that allows decoding at higher speed, or by pre-decoding part of the beginning of the encoded file.

Still further, since the video clips stored in advance in the memory holding unit 40 of the video clip display device 1 are used, there is no need for a plurality of tuners in order to acquire video clips for a plurality of channels. Therefore, the above-described fourth problem does not occur.

Still further, a mode dedicated to a video clip replay is provided to the method of displaying a video clip on an EPG screen. By using video clip videos stored in place of the videos being broadcasted, video information similar to videos being broadcasted can be acquired. Therefore, the above-described fifth problem does not occur.

Still further, a smooth operation equivalent to the zapping operation in the zapping mode can be made even in the zapping mode, thereby solving the above-described sixth problem.

Still further, with provision of the zapping mode dedicated to a video clip replay, functions and operation methods unique to the zapping mode are provided, thereby improving viewers, usability.

Although not described in the above embodiment, an operation of pre-selection in the zapping mode for recording can be performed in a manner similar to that in pre-selection of a program selected in the EPG mode for recording, except that the procedure returns to the zapping mode after the operation of the pre-selection for recording is over. With this, an intuitive user interface that is easy to understand can be provided.

In the above embodiment, the example is shown in which the memory holding unit is included in the video clip display apparatus. Alternatively, an external server or the like connected via a network may be used as the memory holding unit.

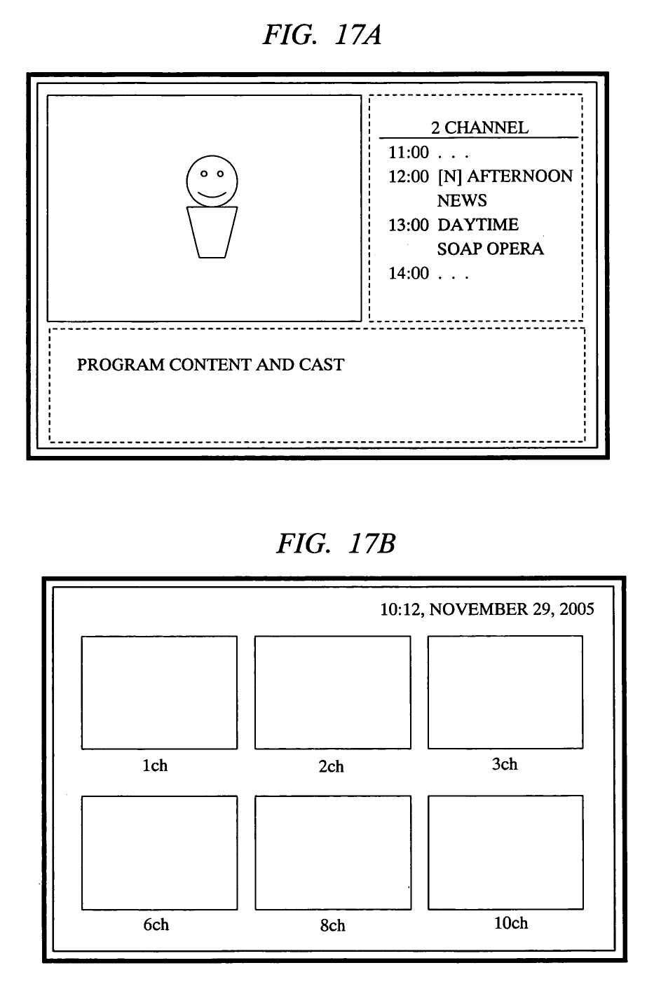

In the above embodiment, the example is shown in which videos in the zapping mode are displayed on the entire screen in consideration of viewability of characters in the videos. Alternatively, as shown in FIG. 17A, the videos may be displayed with EPG information, such as the previous and next program information and the contents, cast, etc., of the selected program. Furthermore, as shown in FIG. 17B, a mode for a thumbnail display of a plurality of clips of the programs may be included.

Next, a second embodiment of the present invention is described. In the first embodiment, the zapping mode is provided, and, in the zapping mode, by using video clips encoded and stored in advance in the memory holding unit 40 so as to be able to be decoded at high speed, a time for waiting for an I frame and a decoding time are reduced, thereby reducing a response time. However, when the channel is to be changed in the TV mode, a time for waiting an I frame and a decoding time are required for a video stream being broadcasted on the channel after change, and therefore it is impossible to make channel switching within a short time. In the second embodiment, at the time of channel switching in the TV mode, before the video stream being broadcasted on the channel after change is displayed, a video clip of the program after switching held in the memory holding unit 40 is replayed for use as a bridge. With this, the information about the program after switching can be quickly obtained, thereby achieving stress-free zapping.

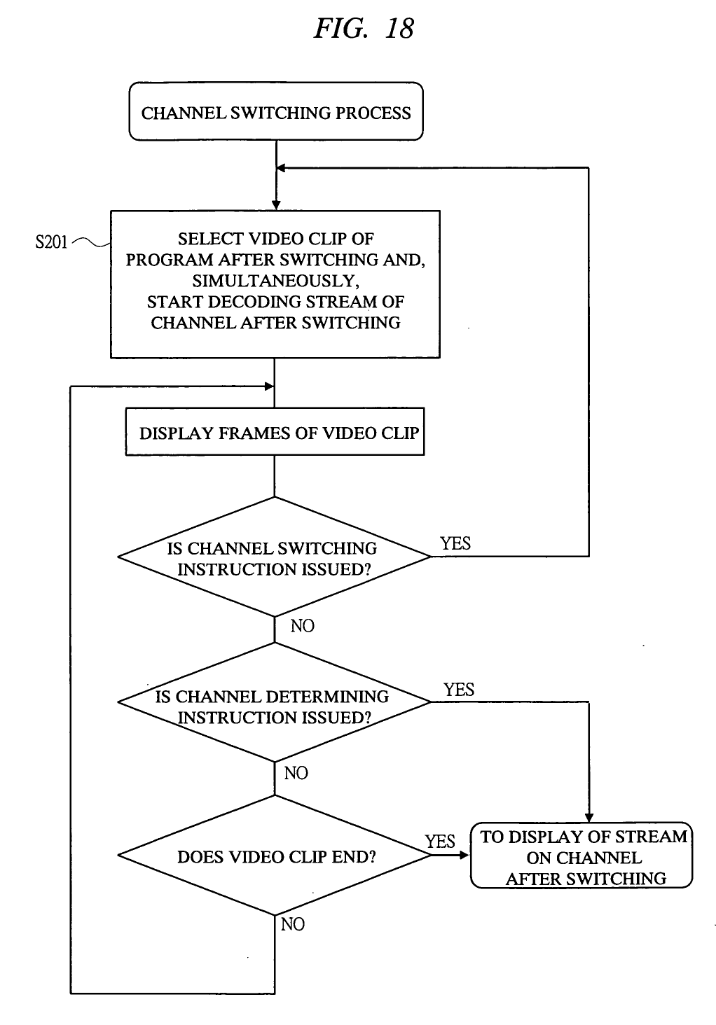

FIG. 18 is a flowchart of an operation of a process when an instruction for channel switching is issued in the TV mode in the second embodiment of the present invention.

Upon reception of a channel switching instruction, in process step S201, a video clip of a program after channel switching held in the memory holding unit 40 is selected and, simultaneously, decoding of a video stream being broadcasted on the channel after switching is started.

While a new channel switching instruction, a channel determining instruction, and the end of the video clip are monitored, each frame of the video clip selected in process step S201 is displayed on the display unit 60, thereby replaying the video clip.

If a new channel switching instruction is issued, the procedure returns to the head of the channel switching process to perform the channel switching process for a new channel.

If a channel determining instruction is issued during the replay of the selected video clip or if the end of the selected video clip is detected, the procedure stops the replay of the video clip and then switches to a display of a video stream on the channel after switching that was started to be decoded in process step S201.

As such, immediately after channel switching, instead of a video stream being broadcasted, which requires some time until its first frame is displayed, a video clip, which requires less time until its first frame is displayed, is replayed and, concurrently, the video stream being broadcasted is decoded. With this, it is possible to achieve high-speed channel switching suitable for zapping and reliable provision of program information so as to prevent a situation such that a commercial message is broadcasted after switching. Also, switching to the subsequent video stream being broadcasted can be made smoothly. Without providing the zapping mode described in the first embodiment, stress-free zapping can also be achieved according to the second embodiment. The first and second embodiments can be achieved not only separately but also in combination.

What is claimed is:

1. A video clip display device comprising:
a broadcast wave receiving unit that receives a television broadcast program;
a display unit that displays the broadcast program received by the broadcast wave receiving unit;
a video clip acquiring unit that acquires a video clip related to the program;
a memory holding unit that stores the video clip acquired by the video clip acquiring unit and program information of the program in association with each other; and
a control unit that performs a process in a zapping mode in which the video clip stored in the memory holding unit is sequentially displayed on the display unit.

2. The video clip display device according to claim 1, wherein when the video clip is displayed in the zapping mode, the control unit causes a character or a symbol indicative of the zapping mode to be displayed on the display unit.

3. The video clip display device according to claim 1, wherein
the memory holding unit has stored therein either one of a default image and a default moving picture corresponding to a genre of the broadcast program, and
when the video clip is displayed in the zapping mode, the control unit causes either one of the default image and the default moving picture corresponding to the genre of the broadcast program stored in the memory holding unit to be displayed if the video clip corresponding to the program cannot be acquired.

4. The video clip display device according to claim 3, wherein
when the video clip is displayed in the zapping mode, the control unit causes program information of the program to be displayed if the video clip corresponding to the program cannot be acquired and the genre of the program cannot be specified.

5. The video clip display device according to claim 1, wherein
when a transition is made from a TV mode in which the program being broadcasted is displayed to the zapping mode, the control unit causes a video clip of a program at a current time on a channel selected in the TV mode to be first displayed.

6. The video clip display device according to claim 1, wherein
when a transition is made from an EPG mode in which electronic program information of the program is displayed to the zapping mode, the control unit causes a video clip of a program selected in the EPG mode to be first displayed.

7. The video clip display device according to claim 1, wherein when the video clip is displayed in the zapping mode, after a display of the video clip being replayed ends, the control unit causes a video clip of a program on either one of a previous channel or a next channel in a same time zone to be next replayed.

8. The video clip display device according to claim 1, wherein
when the video clip is displayed in the zapping mode, after a display of the video clip being replayed ends, the control unit causes a video clip of a program on a same channel in either one of a previous time zone or a next time zone to be next replayed.

9. The video clip display device according to claim 1, wherein when the video clip is displayed in the zapping mode, after a display of the video clip being replayed ends, the control unit causes either one of a video clip of a program a predetermined time previous to the displayed video clip and a video clip of a program a predetermined time next to the displayed video clip on a same channel to be next replayed.

10. The video clip display device according to claim 1, wherein when the video clip is displayed in the zapping mode, upon reception of an instruction for skipping, the control unit ends a replay of the video clip currently being replayed and replays a video clip to be next replayed.

11. A video clip display device comprising:
a broadcast wave receiving unit that receives a television broadcast program;
a display unit that displays the broadcast program received by the broadcast wave receiving unit;
a video clip acquiring unit that acquires a video clip related to the program;
a memory holding unit that stores the video clip acquired by the video clip acquiring unit and program information of the program in association with each other; and
a control unit that causes, immediately after a channel switching instruction, a video clip of a program after switching to be replayed and displayed on the display unit.

12. The video clip display device according to claim 11, wherein
when the video clip of the program after switching immediately after the channel switching instruction is replayed, the control unit causes, upon either one of a reception of a channel determining instruction and an end of the video clip being replayed, television broadcasting on a channel specified by the channel switching instruction to be displayed.

13. A display control method of a video clip display apparatus, the method comprising the steps of
receiving television broadcasting;
periodically acquiring a video clip related to a broadcast program of the television broadcasting;
storing the video clip and program information of the broadcast program in association with each other; and
displaying the video clip of the broadcast program according to a predetermined rule.

14. The display control method of a video clip display apparatus according to claim 13, further comprising a step of storing either one of a default image and a default moving picture related to a genre of the broadcast program and, when the video clip for the program cannot be acquired, displaying either one of the default image and the default moving picture related to the genre of the broadcast program.

15. The display control method of a video clip display apparatus according to claim 14, further comprising a step of, when the video clip is displayed in the zapping mode, displaying program information of the program if the video clip for the program cannot be acquired and the genre of the program cannot be specified.

16. The display control method of a video clip display apparatus according to claim 13, further comprising steps of:
detecting a channel change instruction; and
when the channel change instruction is detected, acquiring, for each channel and from the program information, a video clip in a broadcast time zone of a broadcast program for which the change instruction is made, and displaying a video clip sequentially acquired in response to the channel change instruction.

17. The display control method of a video clip display apparatus according to claim 13, further comprising the steps of:
detecting a display time zone change instruction; and
when the display time zone change instruction is detected, acquiring, for each time zone and from the program information, a video clip of a broadcast program for which the change instruction is made, and displaying the video clip sequentially acquired in response to the change instruction.

18. The display control method of a video clip display apparatus according to claim 13, wherein while the video clip is being displayed, a decode process is performed so that a broadcast wave of the broadcast program of the video clip is received for display, and a switching is made to a display of a broadcast program received either one of at an end of displaying the video clip and during a display of the video clip.

19. The display control method of a video clip display apparatus according to claim 13, further comprising the steps of:
acquiring an URL indicative of a location of the video clip of the broadcast program from the program information; and
acquiring the video clip via the Internet by using the URL.

20. The display control method of a video clip display apparatus according to claim 13, further comprising a step of displaying, on a part of a display of the video clip, an indication that a clip display is being performed when the video clip is displayed.
